(19) United States
(12) Patent Application Publication
(10) Pub. No.: US 2003/0226797 A1
(43) Pub. Date: Dec. 11, 2003

(54) Fibre membrane arrangement

(76) Inventor: Roger Phelps, Seven Hills (AU)

Correspondence Address: KNOBBE MARTENS OLSON & BEAR LLP, 2040 MAIN STREET, FOURTEENTH FLOOR, IRVINE, CA, 92614, US

(21) Appl. No.: 10/423,044

(22) Filed: Apr. 23, 2003

Related U.S. Application Data
(63) Continuation of application No. PCT/AU01/01350, filed on Oct. 22, 2001.

(30) Foreign Application Priority Data
Oct. 23, 2000 (AU) PRO946

(51) Int. Cl. B01D 63/00

(52) U.S. Cl. 210/321.89; 210/321.8

(57) ABSTRACT

A method of reducing solids fouling between porous membranes in a membrane filtration system of the type having a plurality of membranes mounted, at least at one end, to a header and operable to withdraw permeate from multicomponent liquid substrate in which said porous membranes are immersed, the method including rendering a portion of one or more of the membranes, adjacent the header, inoperative.

### FIELD OF THE INVENTION

The present invention relates to membrane filtration systems and more particularly to such systems using porous hollow fibre membranes.

The invention will be described with respect to its application to a membrane bioreactor (MBR) process, however, it will be appreciated that the invention is not limited to such an application and may be equally useful in other processes using hollow fibre membranes or the like. The term “porous” is intended to include “permeable” membranes.

### BACKGROUND ART

Any discussion of the prior art throughout the specification should in no way be considered as an admission that such prior art is widely known or forms part of common general knowledge in the field.

The membrane bioreactor process is used for the treatment of various waste waters. Within this process the filtration module comes in contact with and filters a thickened concentration of mixed liquor that is developed in the process. Therefore it has been found that the filter module has an increased potential of solids fouling due to the thick nature of the material it is filtering.

The membrane reactor process typically uses aeration and/or mixed liquor flow in and around the filter modules to scrub the fibres and create fluid transfer around the fibres. This has the effect of reducing solids fouling. It is the movement of the fibres relative to the flow of mixed liquor within the module and around the fibres that minimises solids fouling.

When solids fouling does occur within a module it typically starts from either of its ends. Once started, the solids fouling may grow from the ends towards the centre of the module and may cause the module to become inoperable. There are a number of mechanisms that influence this. Two of these are described below.

The first mechanism is created by the nature of the module construction. As shown in the example of FIGS. 1, 2a and 2b, at each end of the module 5, the fibre 6 is held by the material 7 it is potted into and hence is restricted in movement. As there is no or limited movement of fibre 6 in this area, fluid transfer is poor. As shown in FIG. 3, the fibre 6 is unable to shake loose any solids 8 that may become caught between the fibres 6 and hence they become trapped and begin the fouling process. The collective trapped solids at this point are still quite soft and well hydrated.

The second mechanism that also works to cause solids fouling is the filtration process itself. The process of filtration sucks the liquid out of the mixed liquor through the fibre membrane 6 and causes the mixed liquor to become thicker. With the effective gas scrubbing and fibre movement, the remaining solids are continuously mixed and diluted back into the bulk mixed liquor and moved away from the membrane surface by effective fluid transfer around the membranes 6. This mixing is achieved by a combination of aeration and/or mixed liquor flow within the process. If during filtration, mixing does not occur, solids are not removed from the membrane surface. In this case, the mixed liquor close to the membrane 6 will continue to thicken as water is sucked from it. A dehydrated sludge will begin to form around the membranes/fibres 6, and in combination with other similar fouled fibres, will cause solids fouling to the module 5.

Hence, at the ends of the modules 5, both mechanisms occur. There is limited mixing and fibre movement, which encourages solids entrapment, and combined with the filtration process, dehydrates the mixed liquor that is trapped between the fibres 6. A thick sludge then forms around the fibres 6 leaving them bound together by a dehydrated sludge.

### DISCLOSURE OF THE INVENTION

The present invention seeks to overcome or at least ameliorate one or more of the disadvantages of the prior art described above or at least provide the public with a useful alternative.

According to a first aspect, the present invention provides a method of reducing solids fouling between porous membranes in a membrane filtration system of the type having a plurality of membranes mounted, at least at one end, to a header and operable to withdraw permeate from multicomponent liquid substrate in which said porous membranes are immersed, the method including rendering a portion of one or more of the membranes, adjacent the header, inoperative.

For preference, the membranes are rendered inoperative by sealing the membrane pores in the portion of the membranes adjacent the header. Preferably, said porous membranes are hollow fibre membranes. For further preference, the hollow fibres extend between spaced opposed headers. Preferably, the portion of the membranes rendered inoperative extends for a predetermined distance from the interface between the header and the membranes.

The invention includes in another aspect, a filtration system modified in accordance with the method of the first aspect.

### BRIEF DESCRIPTION OF DRAWINGS

A preferred embodiment of the invention will now be described, by way of example only, with reference to the accompanying drawings in which:

FIG. 1 shows a schematic side elevation of a typical hollow fibre membrane module to which the present invention is applicable;

FIGS. 2a and 2b show an enlarged side and plan view, respectively of the circled region of FIG. 1;

FIG. 3 shows an enlarged schematic side elevation view of the base of the module of FIG. 1 illustrating solids fouling; and

FIG. 4 shows a similar view to FIG. 1 with the membranes modified according to the invention.

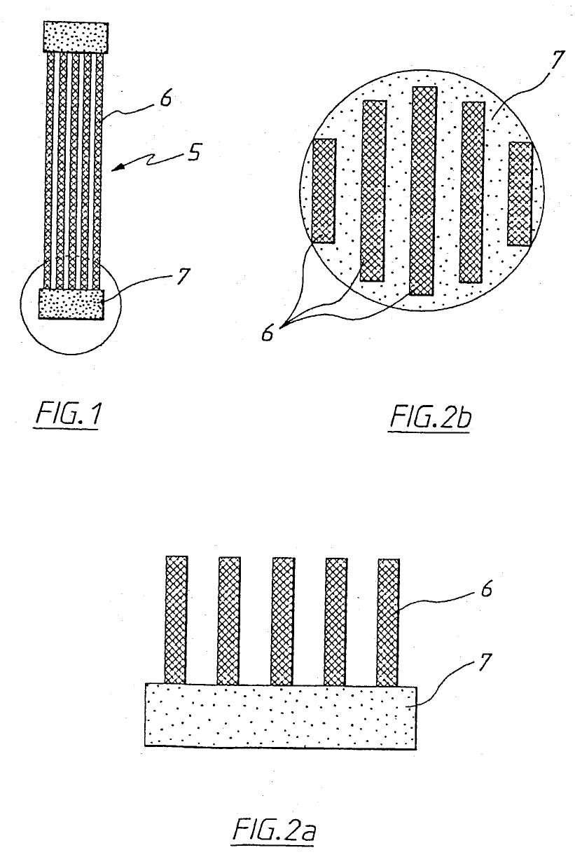

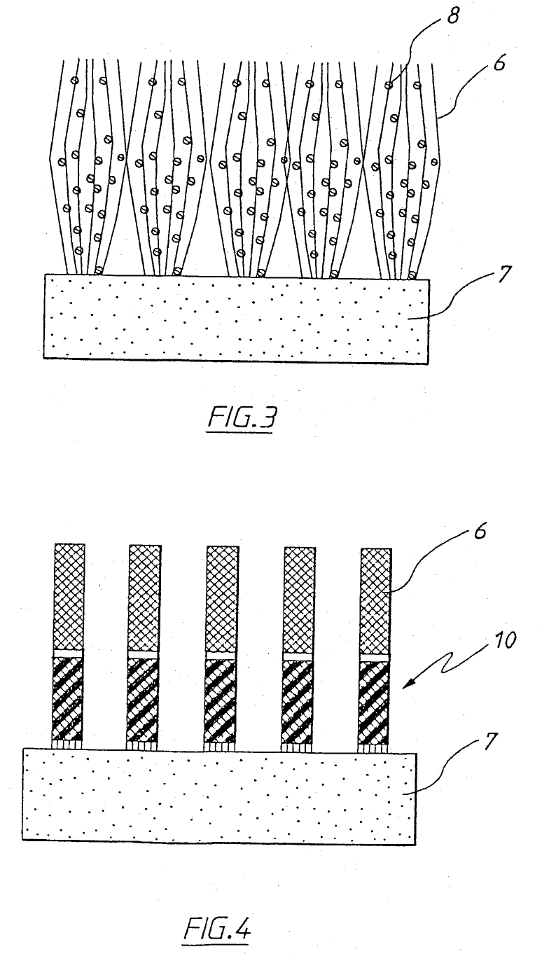

### DESCRIPTION OF PREFERRED EMBODIMENT

Referring to FIG. 4, this embodiment of the invention seeks to reduce or eliminate the second mechanism, filtration, from effecting the ends of the modules 5 by forming a limited non-operative fibre portion 10. FIG. 4 illustrates the portion 10 of the fibre 6, which is to be modified so filtration does not occur. This portion 10 has limited mixing, fibre movement and fluid transfer around the fibres 6. Hence by modifying the fibres 6 in this portion 10 so they do not filter, the two mechanisms described above are not able to work in unison to form a dehydrated sludge around the fibres 6. This serves to prevent clogging between the fibres 6 and eventual reduction in efficiency of the filtration process.

It will be appreciated that further embodiments and exemplifications of the invention are possible, without departing from the spirit or scope of the invention described.

What is claimed is:

1. A method of reducing solids fouling between porous membranes in a membrane filtration system comprising a plurality of membranes mounted, at least at one end, to a header and operable to withdraw permeate from a multicomponent liquid substrate in which the porous membranes are immersed, the method comprising the step of rendering a portion of a membrane adjacent the header inoperative.

2. A method according to claim 1 wherein the membrane is rendered inoperative by sealing membrane pores in the portion of the membrane adjacent the header.

3. A method according to claim 1 wherein the portion of the membrane rendered inoperative extends for a distance from an interface between the header and the membrane.

4. A method according to claim 2 wherein the portion of the membrane rendered inoperative extends for a distance from an interface between the header and the membrane.

5. A method according to claim 1 wherein the porous membranes comprise hollow fibre membranes extending between spaced opposed headers.

6. A membrane filtration system comprising a plurality of membranes mounted, at least at one end, to a header and operable to withdraw permeate from a multicomponent liquid substrate in which the porous membranes are immersed, wherein a portion of a membrane adjacent the header is rendered inoperative.

7. A membrane filtration system according to claim 6 wherein membrane pores in the portion of the membrane adjacent the header are sealed to render the membrane pores inoperative.

8. A membrane filtration system according to claim 6 wherein the portion of the membrane rendered inoperative extends for a distance from an interface between the header and the membrane.

9. A membrane filtration system according to claim 7 wherein the portion of the membrane rendered inoperative extends for a distance from an interface between the header and the membrane.

10. A membrane filtration system according to claim 6 wherein the porous membranes are hollow fibre membranes extending between spaced opposed headers.
